(19) United States
(12) Patent Application Publication
(10) Pub. No.: US 2014/0359530 A1
(43) Pub. Date: Dec. 4, 2014

(54) ELECTRONIC DEVICE FOR MANAGING ICONS REPRESENTING APPLICATIONS

(71) Applicant: HON HAI PRECISION INDUSTRY CO., LTD., New Taipei (TW)

(72) Inventor: HONG-SHENG CHEN, New Taipei (TW)

(73) Assignee: HON HAI PRECISION INDUSTRY CO., LTD., New Taipei (TW)

(21) Appl. No.: 14/025,831

(22) Filed: Sep. 13, 2013

(30) Foreign Application Priority Data
Jun. 4, 2013 (TW) 102119685

(51) Int. Cl. G06F 3/0482

(52) U.S. Cl. CPC G06F 3/0482
USPC 715/835

(57) ABSTRACT

An electronic device divides a display of the electronic device into a first display area and a second display area. The first display area displays the icons representing the applications, and the second display area displays a number of buttons for controlling the icons representing the applications. The electronic device determines which buttons in the second display area is selected and which icon representing the applications is selected. The electronic device further manages the selected icon according to the function of the selected button in the second display area.

### BACKGROUND

1. Technical Field

The present disclosure relates to electronic devices, and particularly to an electronic device capable of managing icons representing applications.

2. Description of Related Art

A smart TV allows users to install and run applications based on a specific platform. Therefore, there are a number of icons representing applications (hereinafter, icons) of the smart TV. The users manage the icons, such as constitute a group icon including a number of icons for example, often by operating a mouse connected to the smart TV or by touching the smart TV, and a remote control is needed for other operations, which may bring inconvenience to the users.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of an electronic device for managing icons representing applications, in accordance with an exemplary embodiment.

FIG. 2 is a block diagram of a managing system of FIG. 1, in accordance with an exemplary embodiment.

FIGS. 3-5 are schematic views of an interface provided by the managing system of FIG. 1.

### DETAILED DESCRIPTION

Embodiments of the present disclosure are described in detail, with reference to the accompanying drawings.

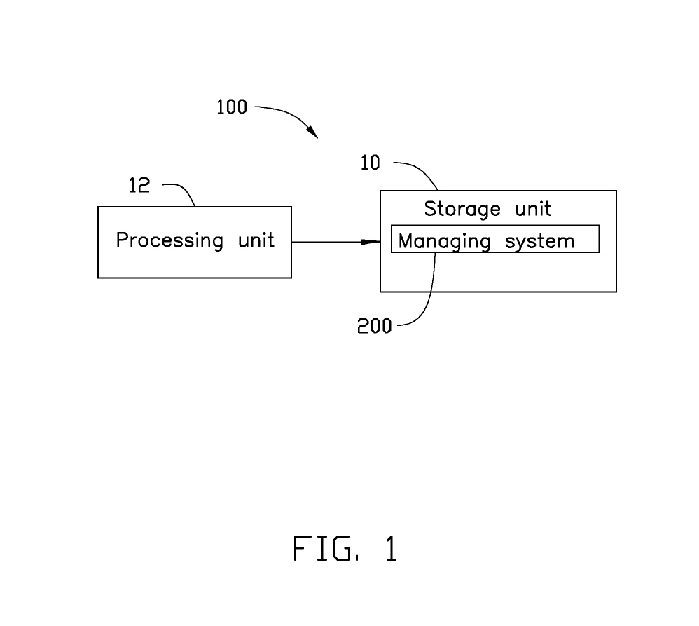

FIG. 1 shows an embodiment of an electronic device 100 for managing icons representing applications (hereinafter icons) of the electronic device 100. In this embodiment, the electronic device 100 is a smart TV, and can be controlled by a remote control (not shown). The electronic device 100 includes a storage unit 10, a processing unit 12, and a display 14. The storage unit 10 stores a number of modules of a managing system 200. The processing unit 12 executes the number of modules of the managing system 200 to manage the icons of the electronic device 100.

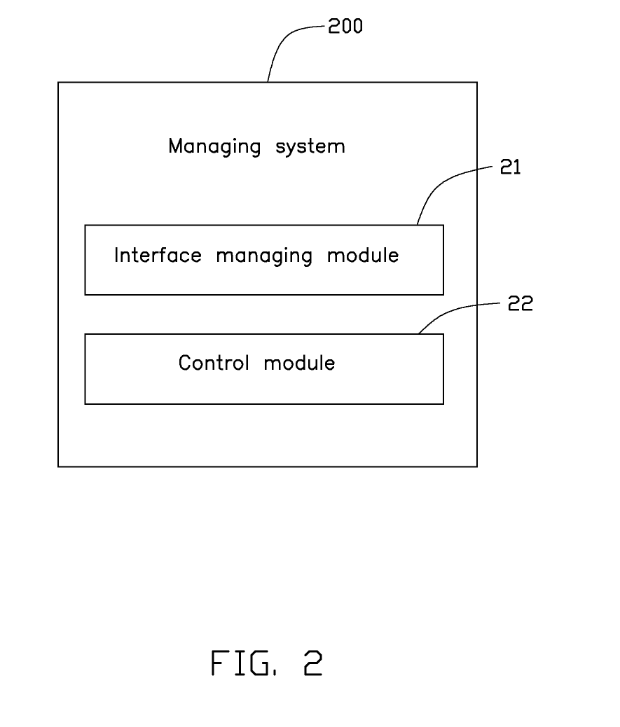

FIG. 2 shows that the managing system 200 includes an interface managing module 21 and a control module 22 which are collection of software instructions.

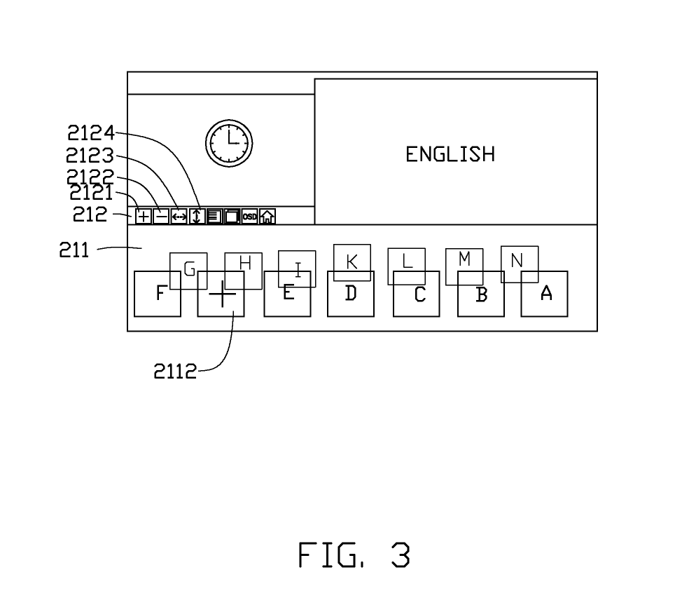

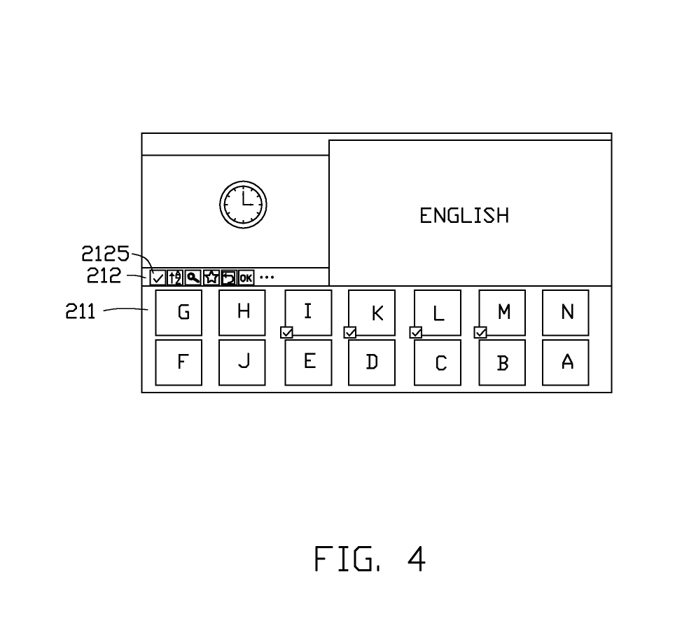

Referring to FIGS. 3-4, when the electronic device 100 is started, the interface managing module 100 divides the display 14 into a first display area 211 and a second display area 212. The first display area 211 displays the icons. The second display area 212 displays a number of buttons for controlling the icons in the first display area 211. In this embodiment, the interface managing module 21 switches a display mode of the icons between a first display mode and a second display mode according to the function of a selected button in the second display area 212 (see the change from FIG. 3 to FIG. 4). The interface managing module 21 further changes the buttons in the second display area 212 when the display mode of the icons is switched between the first display mode and the second display mode (see the change from FIG. 3 to FIG. 4). In this embodiment, the first display mode is that the icons are displayed in different layers, and each layer displays a preset number of icons (FIG. 3). The icons of the top layer are non-transparent, and the icons of the other layers are transparent. The second display mode is that the icons are displayed in a same layer (FIG. 4).

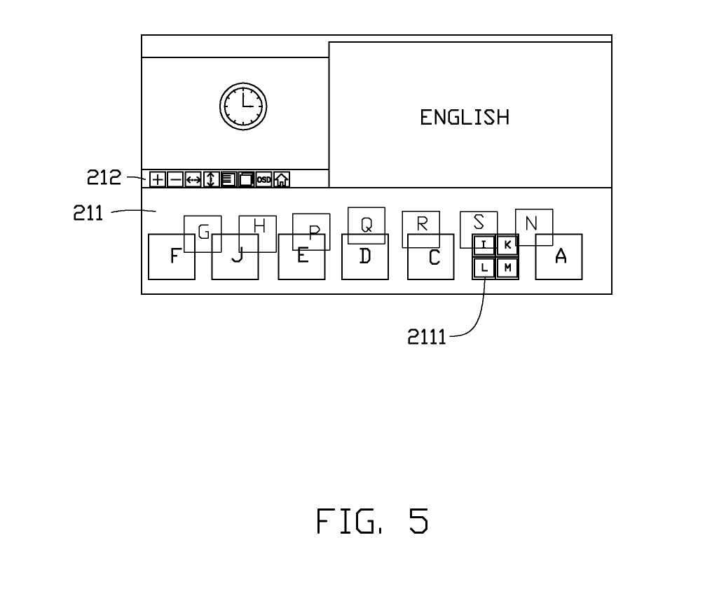

In this embodiment, the buttons in the second display area 212 includes a button 2121 for adding a group, a button 2122 for deleting an icon, a button 2123 for moving an icon, a button 2125 for selecting an icon, for example. The buttons 2121, 2122, and 2123 are displayed when the display mode of the icons is in the first display mode. The button 2125 is displayed when the display mode of the icons is in the second display mode. When the button 2121 is selected, the interface managing module 21 switches the display mode of the icons from the first display mode to the second display mode, and changes the buttons in the second display area 212. The control module 22 determines the selected icons when the display mode of the icons is switched to the second display mode, and constitutes a group icon including the selected icons (see FIG. 5). That is, to constitute a group icon, the button 2121 is selected, and the display mode of the icons is then switched to the second display mode. In the second display mode, the button 2125 is selected, and direction buttons and a confirm button of the remote control are operated to select icons to be added to the group icon (see FIG. 4). After finishing selecting icons, the OK button of the second display area 212 is selected, and the group icon is constituted. When the group icon is constituted, the interface managing module 21 switches the display mode of the icons to the first display mode, and displays the group icon in the first display area 211 (see FIG. 5).

When the button 2123 or 2124 is selected, the control module 22 responds to user operation on direction buttons of the remote control to move the selected icon in the first display area 211.

When the button 2122 is selected, the control module 22 deletes the selected icon from the first display area 211 and displays a blank icon representing no application in a position of the deleted icon.

When the blank icon 2112 is selected, the interface control module 21 switches the display mode of the icons from the first display mode to the second display mode. When the display mode of the icons is in the second display mode, if only one icon is selected, the control module 22 changes the blank icon to the selected icon when the display mode of the icons is switched back to the first display mode, and if a number of selected icons are selected, the control module 22 changes the blank icon to a group icon including the number of selected icons when the display mode of the icons is switched back to the first display modes. That is, when the user wants to add an icon representing one application or a group icon to the position of the blank icon 2112, the blank icon 2112 is selected, and the display mode of the icons is switched to the second display mode. One or more icons can be selected with the cooperation of the buttons in the second display area and the buttons of the remote control. When only one icon is selected, the blank icon is changed to the selected icon when the display mode of the icons is switched to the first display mode. When a number of icons are selected, the blank icon is changed to a group icon including the number of selected icons.

In this embodiment, by virtue of the buttons in the second display area 212, the users can add an icon, delete an icon, and constitute a group icon by the remote control, thus it is convenient for the users to manage the icons of the electronic device 100 without directly touching the electronic device 100 or operating a mouse connected to the electronic device 100.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a display;
a storage unit storing a plurality of modules of a managing system; and
a processing unit to execute the plurality of modules of the managing system to perform operations of managing icons representing applications of the electronic device, the operations comprising:
dividing the display into a first display area and a second display area, wherein the first display area displays the icons representing the applications, and the second display area displays a plurality of buttons for controlling the icons representing the applications; and
determining which one of the buttons in the second display area is selected and which one of the icons representing the applications is selected, and managing the selected icon according to the function of the selected button in the second display area.

2. The electronic device as described in claim 1, wherein the operations further comprising:
switching a display mode of the icons representing the applications between a first display mode and a second display mode according to the function of the selected button in the second display area, and changing the buttons in the second display area when the display mode of the icons is switched between the first display mode and the second display mode.

3. The electronic device as described in claim 2, wherein the first display mode is that the icons representing the applications is displayed in different layers, each layer displays a preset number of icons representing the applications, the icons of the top layer are non-transparent, and the icons of the remaining layers are transparent, the second display mode is that the icons are displayed in a same layer.

4. The electronic device as described in claim 2, wherein the operations further comprising:
switching the display mode of the icons representing the applications from the first display mode to the second display mode when the button for constituting a group is selected;
determining the selected icons representing the applications when the display mode of the icons representing the applications is switched to the second display mode, and constituting a group icon comprising the selected icons; and
switching the display mode of the icons representing the applications to the first display mode when the group icon is constituted, and displaying the group icon in the first display area.

5. The electronic device as described in claim 2, wherein the operations further comprising:
displaying a blank icon representing no application in the first display area;
switching the display mode of the icons representing the application from the first display mode to the second display mode when the blank icon is selected;
changing the blank icon to the icon representing one application of the electronic device after the display mode of the icons representing the applications is switched back to the first display mode if only one icon representing one application is selected in the second display mode; and
changing the blank icon to a group icon comprising a plurality of selected icons after the display mode of the icons representing the applications is switched back to the first display mode if more than one icon is selected in the second display mode.

6. The electronic device as described in claim 1, wherein the operations further comprising:
deleting one selected icon representing one application from the first display area when the function of the selected button is deleting an icon; and
displaying a blank icon representing no application in a position of the deleted icon.

7. The electronic device as described in claim 1, wherein the operations further comprising:
moving the selected icon representing one application when the function of the selected button is moving an icon.

8. A computer-readable storage medium encoded with a computer program, the program comprising instructions that when executed by an electronic device to perform operations of managing icons representing applications of the electronic device, the operations comprising:
dividing a display of the electronic device into a first display area and a second display area, wherein the first display area displays the icons representing the applications, and the second display area displays a plurality of buttons for controlling the icons representing the applications; and
determining which one of the buttons in the second display area is selected and which one of the icons representing the applications is selected, and managing the selected icon according to the function of the selected button in the second display area.

9. The storage medium as described in claim 8, wherein the operations further comprising:
switching a display mode of the icons representing the applications between a first display mode and a second display mode according to the function of the selected button in the second display area, and changing the buttons in the second display area when the display mode of the icons is switched between the first display mode and the second display mode.

10. The storage medium as described in claim 9, wherein the first display mode is that the icons representing the applications is displayed in different layers, each layer displays a preset number of icons representing the applications, the icons of the top layer are non-transparent, and the icons of the remaining layers are transparent, the second display mode is that the icons are displayed in a same layer.

11. The storage medium as described in claim 9, wherein the operations further comprising:
switching the display mode of the icons representing the applications from the first display mode to the second display mode when the button for constituting a group is selected;
determining the selected icons representing the applications when the display mode of the icons representing the applications is switched to the second display mode, and constituting a group icon comprising the selected icons; and
switching the display mode of the icons representing the applications to the first display mode when the group icon is constituted, and displaying the group icon in the first display area.

12. The storage medium as described in claim 9, wherein the operations further comprising:
displaying a blank icon representing no application in the first display area;
switching the display mode of the icons representing the application from the first display mode to the second display mode when the blank icon is selected;
changing the blank icon to the icon representing one application of the electronic device after the display mode of the icons representing the applications is switched back to the first display mode if only one icon representing one application is selected in the second display mode; and
changing the blank icon to a group icon comprising a plurality of selected icons after the display mode of the icons representing the applications is switched back to the first display mode if more than one icon is selected in the second display mode.

13. The storage medium as described in claim 8, wherein the operations further comprising:
deleting one selected icon representing one application from the first display area when the function of the selected button is deleting an icon; and
displaying a blank icon representing no application in a position of the deleted icon.

14. The storage medium as described in claim 8, wherein the operations further comprising:
moving the selected icon representing one application when the function of the selected button is moving an icon.
